(19) United States
(12) Patent Application Publication
(10) Pub. No.: US 2025/0086787 A1
(43) Pub. Date: Mar. 13, 2025

(54) LIVER CIRRHOSIS DETECTION IN DIGITAL IMAGES

(71) Applicant: Hoffmann-La Roche Inc., Little Falls, NJ (US)

(72) Inventors: Szymon Grzegorz ADAMSKI, Gliwice (PL); Benjamin GUTIERREZ BECKER, Basel (CH); Krzysztof KOTOWSKI, Gliwice (PL); Agata KRASON, Bühler (CH); Damian Marek KUCHARSKI, Gliwice (PL); Bartosz Jakub MACHURA, Gliwice (PL); Jakub Robert NALEPA, Gliwice (PL); Jean TESSIER, Muespach (FR)

(73) Assignee: Hoffmann-La Roche Inc., Little Falls, NJ (US)

(21) Appl. No.: 18/798,454

(22) Filed: Aug. 8, 2024

Related U.S. Application Data
(63) Continuation of application No. PCT/EP2023/052889, filed on Feb. 7, 2023.

(30) Foreign Application Priority Data
Feb. 9, 2022 (EP) 22155886.9

(51) Int. Cl. G06T 7/00

(52) U.S. Cl. CPC G06T 7/0012; G06T 2207/10081; G06T 2207/20081; G06T 2207/30056

(57) ABSTRACT

The present invention relates to systems and methods to detect liver cirrhosis in digital images. Various embodiments of the present invention relate to systems and methods to detect liver cirrhosis in computed tomography (CT) scans and, more specifically but not limited, to systems and methods to detect liver cirrhosis via a model trained on highly-interpretable features.

The present invention relates to systems and methods to detect liver cirrhosis in digital images. Various embodiments of the present invention relate to systems and methods to detect liver cirrhosis in computed tomography (CT) scans and, more specifically but not limited, to systems and methods to detect liver cirrhosis via a model trained on highly-interpretable features.

CT technique is based on the different attenuation of X-rays in the different body tissues. Multiple CT images taken from different angles during the same scan, also referred to as CT slices, allow for cross-sectional images to be produced with reconstruction algorithms. CT scans require expert radiologists to read and annotate the acquired images. CT scans can be performed without contrast or with contrast, the latter in different phases. Depending on the purpose of the investigation, each phase is defined by a standardized protocol regulating the time intervals between intravenous radiocontrast administration and image acquisition, in order to visualize the dynamics of contrast enhancements in different organs and tissues. As known to the person skilled in the art, the portal/venous CT scan, also known as late portal or hepatic CT scan, is a contrast-enhanced CT scan in portal/venous phase, characterized by a time interval of 70-80 seconds between radiocontrast administration and image acquisition. Portal/venous CT scans enhance the portal vein and hepatic veins, thus offering the best hepatic enhancement for cirrhosis diagnosis. Other possible phases for cirrhosis diagnosis comprise early arterial phases, late arterial phase, delayed phase, according to the different regions enhanced. CT scan densities are measured in terms of Hounsfield Units (HUs). A change of one HU represents a change of 0.1% of the attenuation coefficient of water.

CT scans can be used to characterize the cirrhotic state of a liver, i.e. to detect whether or not a liver presents cirrhosis (severe fibrosis) 1. Several CT imaging biomarkers identified manually by medical experts analysing the CT scans can characterize different stages of liver diseases such as fibrosis and cirrhosis: liver bluntness, liver surface nodularity (LSN), ascites. A liver shows bluntness when its edges or corners are not sharp or clear. In particular the bluntness of the left liver corner, defined as the anatomically left corner of the liver, is one of the most common signs of cirrhosis (see² liver edges in FIG. 1). No automatic liver bluntness extractor from medical imaging exists in the literature. The LSN score is one of the most popular metrics with documented effectiveness used to quantify LSN and therefore the grade of liver disease (see³ FIGS. 4c and 4f). The LSN score is calculated as a mean distance between a small part of the segmented liver contour and a spline or polynomial fit to it. The most challenging part is the choice of the liver contour part to be used, which is typically performed by radiologists, thus allowing for the existence of only semi-automatic algorithms to calculate the LSN score. Ascites are abnormal accumulation of serous fluid in the spaces between tissues and organs in the abdominal cavity. In the developed world, the most common cause of ascites is liver cirrhosis. Ascitic fluid is traditionally characterized as either transudate (thin, low protein count and low specific gravity) or exudate (high protein count and high specific gravity). The main cause of transudative ascites are cirrhosis and alcoholic hepatitis. CT scans are sensitive to the different types of ascitic fluid: CT densities between −10 and +10 HU correspond to transudative ascites; CT densities larger than 15 HU correspond to exudative ascites. No automatic ascites extractor from medical imaging exists in the literature.

Also Artificial Intelligence (AI) algorithms, in particular Machine-Learning (ML) algorithms, have been used for fibrosis staging and cirrhosis detection. The most common ML technique employed in this field to extract features from CT scans is Deep Learning (DL) 4.5, although the features extracted from DL algorithms are difficult to interpret and to link to easily-explainable biomarkers. A partial solution to this problem is provided by radiomics, one of the leading approaches^{6,7,8,9} in the prediction of medical conditions from medical imaging. Radiomics offers a set of standardized feature extractors linked to well-known biomarkers and largely explainable to users, however the interpretability of such features is hindered by the amount (hundreds) of feature extractors. Thus there is a need for a computer-aided solution with increased interpretability of the features extracted in liver cirrhosis detection.

### BIBLIOGRAPHY

¹Choi et al, “Development and Validation of a Deep Learning System for Staging Liver Fibrosis by Using Contrast Agent-enhanced CT Images in the Liver”, Radiology; 289 (3): 688-697; 2018.
²Choong et al. “Accuracy of routine clinical ultrasound for staging of liver fibrosis”, J. Clin Imaging Sci; 2:58; 2012.
³Smith et al, “Liver Surface Nodularity Score Allows Prediction of Cirrhosis Decompensation and Death”, Radiology; 283 (3): 711-722:2017.
⁴Yu et al, “Deep learning enables automated scoring of liver fibrosis stages”, Scientific Reports; vol 8:16016; 2018.
⁵Yin et al. “Liver fibrosis staging by deep learning: a visual-based explanation of diagnostic decisions of the model”, Eur Radiol 31 (12): 9620-9627:2021.
⁶Wang et al, “A radiomics-based model on non-contrast CT for predicting cirrhosis: make the most of image data”, Biomarker Research 8:47; 2020.
⁷Wei et al, “Radiomics in liver diseases: Current progress and future opportunities”, Liver Int 40 (9): 2050-2063, 2020.
⁸Ji et al, “Machine-learning analysis of contrast-enhanced CT radiomics predicts recurrence of hepatocellular carcinoma after resection: A multi-institutional study”, EBioMedicine 50:156-165, 2019.
⁹Budai et al. “Three-dimensional CT texture analysis of anatomic liver segments can differentiate between low-grade and high-grade fibrosis”, BMC Med Imaging; 20:108, 2020.

### BRIEF DESCRIPTION OF THE DRAWINGS

FIG. 1 illustrates an exemplary instance of a system for cirrhosis detection in a digital image, in accordance with an example of the invention.

FIG. 2 depicts a block diagram that illustrates an exemplary data processing apparatus for cirrhosis detection in a digital image, in accordance with an example of the invention.

FIG. 3 depicts a flow chart that illustrates an exemplary method for cirrhosis detection in a digital image, in accordance with an example of the invention.

FIG. 4 illustrates one example of liver segmentation before (left) and after (right) voxel normalization, in accordance with an example of the invention.

FIG. 5a depicts a flow chart that illustrates an exemplary method for the extraction of a region of interest, in particular the rectified liver contour, in a digital image comprising a liver, in accordance with an example of the invention.

FIG. 5b illustrates the view (left) and a zoomed-in view (right) of an axial liver CT slice with contours marked, comprising a rectified liver contour (bottom part of the left image), in accordance with an example of the invention.

FIG. 6 depicts a flow chart that illustrates an exemplary method for the extraction of a feature, in particular the liver bluntness, in accordance with an example of the invention.

FIG. 7 depicts a flow chart that illustrates an exemplary method for the extraction of a feature, in particular the liver surface nodularity (LSN) or LSN score, in accordance with an example of the invention.

FIG. 8a depicts a flow chart that illustrates an exemplary method for the extraction of a feature, in particular the ascites, in accordance with an example of the invention.

FIG. 8b illustrates examples of ascites indicated by arrows in the CT scans from two patients.

FIG. 9 depicts the classification pipeline that illustrates an exemplary method for liver cirrhosis classification, in accordance with an example of the invention.

FIG. 10 depicts a flow chart that illustrates an exemplary method for cirrhosis detection in a digital image, in accordance with an example of the invention.

### DETAILED DESCRIPTION

The present invention relates to systems and methods to detect liver cirrhosis in digital images. Various embodiments of the present invention relate to systems and methods to detect liver cirrhosis in computed tomography (CT) scans and, more specifically but not limited, to systems and methods to detect liver cirrhosis via a model trained on highly-interpretable features.

In the context of the present invention, highly-interpretable features are intended as features extractable from a digital image of a CT scan which are, singularly and in combination, anatomically-associable features and thus easily interpretable by a user. As an example and by no means of limitation, highly-interpretable features can be the liver volume, the spleen volume and the spleen-to-liver ratio, the latter being the ratio between the spleen volume and the liver volume. People suffering from cirrhosis show on average a lower liver volume, a higher spleen volume and a higher spleen-to-liver ratio.

In the present invention, the two terms “extraction” and “selection” have distinct meanings when referring to features. “Feature extraction” relates to techniques and/or algorithms that allow for calculating or estimating said features from the inputted image. “Feature selection” refers to the identification of a subset of the set of extracted features, wherein the selection can be executed for example via an algorithm. In embodiments of the present invention, a subset of features is identified as the subset of the set of extracted features that result in the highest-performant methods to detect liver cirrhosis. The terms “liver volume” and “spleen volume” are used to identify either Regions of Interest (RoI) in the digital images or features. This distinction is made clear by reference to the step of the method being described. In the context of RoIs, liver and spleen volumes are intended as parts of the image wherein interesting features can be extracted. In the context of features, liver and spleen volumes are intended as the results of the calculation of the physical volumes occupied by the liver and spleen in the image.

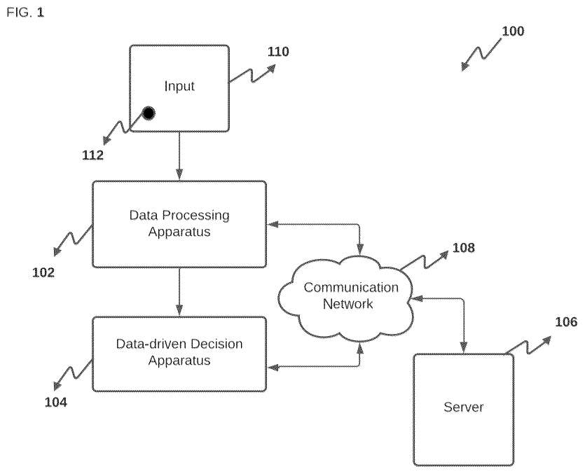

FIG. 1 illustrates an exemplary instance of a system for cirrhosis detection in a digital image, in accordance with an example of the invention. With reference to FIG. 1, the system 100 can include a data processing apparatus 102, a data-driven decision apparatus 104, a server 106 and a communication network 108. The data processing apparatus 102 can be communicatively coupled to the server 106 and the data-driven decision apparatus 104 via the communication network 108. In other embodiments, the data processing apparatus 102 and the data-driven decision apparatus 104 can be embedded in a single apparatus. The data processing apparatus 102 can receive as input a digital image 110 comprising at least a liver 112. In other embodiments, the image 110 can be stored in the server 106 and sent from the server 106 to the data processing apparatus 102 via the communication network 108.

The data processing device 102 can be designed to receive the digital image 110 and perform the cirrhosis classification for the liver 112 in the digital image 110 via at least one trained classifier. The data processing device 102 can allow for the extraction of Regions of Interest of the liver 112, for the extraction of highly-interpretable features, and for the selection of a subset of said features. Examples of the data processing device 102 include but are not limited to a computer workstation, a handheld computer, a mobile phone, a smart appliance. The data-driven decision apparatus 104 can comprise software, hardware or various combinations of these. The data-driven decision apparatus 104 can be designed to receive as input features outputted by the data processing device 102 and, for example in digital images from CT scans, to assess the level of liver diseases such as fibrosis and cirrhosis based on said features. In an embodiment, the data-driven decision apparatus 104 can be able to access from the server 106 the stored features of one liver, extracted while processing different images comprising the liver, whereby these different images can relate to different CT slices. Examples of the data-driven decision apparatus 104 include but are not limited to computer workstation, a handheld computer, a mobile phone, a smart appliance.

The server 106 can be configured to store digital images. In some embodiments, the server 106 can also store metadata related to the digital images. The server 106 can be designed to send the digital image 110 to the data processing apparatus 102 via the communication network 108, and/or to receive the output features of the digital image 110 from the data processing apparatus 102 via the communication network 108. The server 106 can also be configured to receive and store the classification label associated with the digital image from the data-driven decision apparatus 104 via the communication network 108. Examples of the server 106 include but are not limited to application servers, cloud servers, database servers, file servers, and/or other types of servers.

The communication network 108 can comprise the means through which the data processing apparatus 102, the data-driven decision apparatus 104 and the server can be communicatively coupled. Examples of the communication network 108 include but are not limited to the Internet, a cloud network, a Wi-Fi network, a Personal Area Network (PAN), a Local Area Network (LAN) or a Metropolitan Area Network (MAN). Various devices of the system 100 can be configured to connect with the communication network 108 with wired and/or wireless protocols. Examples of protocols include but are not limited to Transmission Control Protocol/Internet Protocol (TCP/IP), Hypertext Transfer Protocol (HTTP), File Transfer Protocol (FTP), Bluetooth (BT).

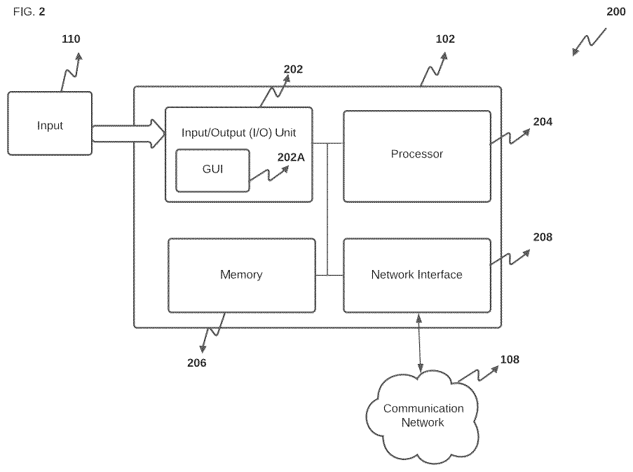

FIG. 2 depicts a block diagram that illustrates an exemplary data processing apparatus for cirrhosis detection in a digital image, in accordance with an example of the invention. FIG. 2 is explained in conjunction with elements from FIG. 1. With reference to FIG. 2, it is shown a block diagram 200 of the data processing apparatus 102. The data processing apparatus 102 can include an Input/Output (I/O) unit 202 further comprising a Graphical User Interface (GUI) 202A, a processor 204, a memory 206 and a network interface 208. The processor 204 can be communicatively coupled with the memory 206, the I/O unit 202, the network interface 208. The I/O unit 202 can comprise suitable logic, circuitry and interfaces that can act as interface between a user and the data processing apparatus 102. The I/O unit 202 can be configured to receive a digital image 110 comprising at least a liver 112. The I/O unit 202 can include different operational components of the data processing apparatus 102. The I/O unit 202 can be programmed to provide a GUI 202A for user interface. Examples of the I/O unit 202 can include, but are not limited to, a touch screen, a keyboard, a mouse, a joystick, a microphone, and a display screen, like for example a screen displaying the GUI 202A.

The GUI 202A can comprise suitable logic, circuitry and interfaces that can be configured to provide the communication between a user and the data processing apparatus 102. In some embodiments, the GUI can be displayed on an external screen, communicatively or mechanically coupled to the data processing apparatus 102. The screen displaying the GUI 202A can be a touch screen or a normal screen.

The processor 204 can comprise suitable logic, circuitry and interfaces that can be configured to execute programs stored in the memory 206. The programs can correspond to sets of instructions for image processing operations, including but not limited to liver segmentation and classification. In some embodiments, the sets of instructions also include the liver characterization operation, including but not limited to feature extraction and selection. The processor 204 can be built on a number of processor technologies known in the art. Examples of the processor 204 can include, but are not limited to, Graphical Processing Units (GPUs), a Central Processing Units (CPUs), motherboards, network cards.

The memory 206 can comprise suitable logic, circuitry and interfaces that can be configured to store programs to be executed by the processor 204. Additionally, the memory 206 can be configured to store the input image 110 and/or its associated metadata. In another embodiment, the memory can store a subset of or the entire training dataset, comprising in some embodiments the pair of images and their associated metadata. Examples of the implementation of the memory 206 can include, but are not limited to, Random Access Memory (RAM), Read Only Memory (ROM), Hard Disk Drive (HDD), Solid State Drive (SDD) and/or other memory systems.

The network interface 208 can comprise suitable logic, circuitry and interfaces that can be configured to enable the communication between the data processing apparatus 102, the data-driven decision apparatus 104 and the server 106 via the communication network 108. The network interface 208 can be implemented in a number of known technologies that support wired or wireless communication with the communication network 108. The network interface 208 can include, but is not limited to, a computer port, a network interface controller, a network socket or any other network interface systems.

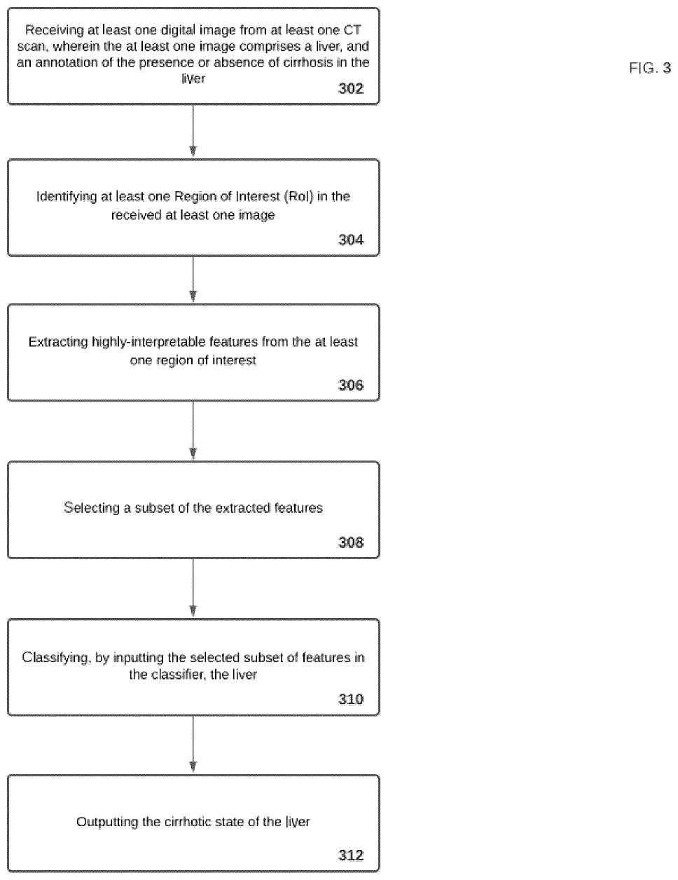

FIG. 3 depicts a flow chart that illustrates an exemplary method for cirrhosis detection in a digital image, in accordance with an example of the invention.

At 302, at least one digital image from at least one CT scan is received, wherein the at least one image comprises a liver, and an annotation of the presence or absence of cirrhosis in the liver. In one example of implementation of the present invention, CT scans collected during a clinical trial involving patients with hepatocellular carcinoma (HCC) were received and analysed, as well as scans from a public domain database from potential liver donors, therefore healthy patients. In particular, the HCC dataset contained 1015 CT scans (385 in portal/venous phase, 305 in arterial phase, 325 in other phases) collected from 395 patients, while the public dataset contained 40 CT scans in portal/venous phase from 40 donors. Both datasets contained an annotation regarding the presence or absence of cirrhosis. The HCC dataset contained also additional metadata, regarding for example the patient's characteristics (age, height, weight, sex, race), the cause of the disease, if previously operated. In this example of implementation of the present invention, most of the received images were relative to CT scans acquired on the same day, or within a time span deemed to be too short to show disease progression, for example 13 days.

In an embodiment of the present invention, a step of preprocessing the received at least one digital image is performed. The step of preprocessing can comprise the steps of removing corrupted images, and/or images with inconsistent annotations, and/or images with incomplete livers. In the example of implementation of the present invention above described, the HCC dataset after preprocessing consisted of 909 CT scans from 354 patients, while the public dataset after preprocessing consisted of 32 scans from 32 donors.

At 304, at least one Region of Interest (RoI) in the received at least one image is identified. RoIs are regions in the image where objects of interest can be found, for example the liver. RoIs can be identified via AI algorithms, in particular ML algorithms. Among existing ML algorithms, Deep Neural Networks (DNNs) have the ability to learn useful features from low-level raw data, and in particular Convolutional Neural Networks (CNNs) are well suited for image recognition tasks. CNNs are built such that the processing units in the early layers learn to activate in response to simple local features, for example patterns at particular orientations or edges, while units in the deeper layers combine the low-level features into more complex patterns. Notably, Region based CNNs (R-CNNs) extract RoIs by identifying region proposals where the object of interest might be located and then applying CNNs to classify the object and locate it within the region proposals by defining a bounding box.

Improved versions of R-CNNs are Fast and Faster R-CNNs, which feed the input image to a CNN to create a feature map before extracting the region proposals, and differ between each other only in the applied region proposal search systems. Mask R-CNNs extend Faster R-CNNs by adding a branch for predicting an object mask in parallel with the branch for object detection. Mask R-CNNs techniques are especially performant in detecting and segmenting overlapping instances. Segmentation algorithms can comprise all of the above mentioned algorithms. Additionally, nnU-Nets, self-configuring DL-based segmentation methods, can be used as segmentation algorithms.

In the example of implementation of the present invention above described, 3 RoIs were extracted: liver volume, spleen volume, and rectified liver contour. Liver volume and spleen volume were extracted via manual segmentations (i.e. performed by the experts) and AI-segmentations (i.e. by using nnU-Net algorithms). Prior to the segmentation, the available datasets were normalized to a common voxel size. A voxel is a volume element (volumetric pixel) representing a value in the three-dimensional space. Typical units of voxel sizes are mm³.

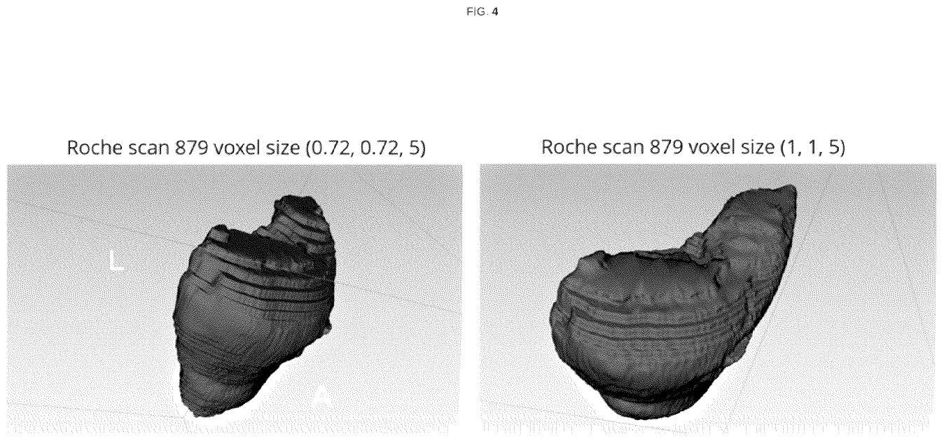

Voxel normalization can remove the dependence of the segmentation on the voxel size of the specific dataset. In the example of implementation of the present invention above described, the normalization was performed such that the maximum voxel size was set to (1,1,5) mm³. The smoothing effect of the voxel normalization on the segmentation of the liver is illustrated for one example scan in FIG. 4, where the liver segmentation before normalization (left) and the liver segmentation after normalization (right) are shown.

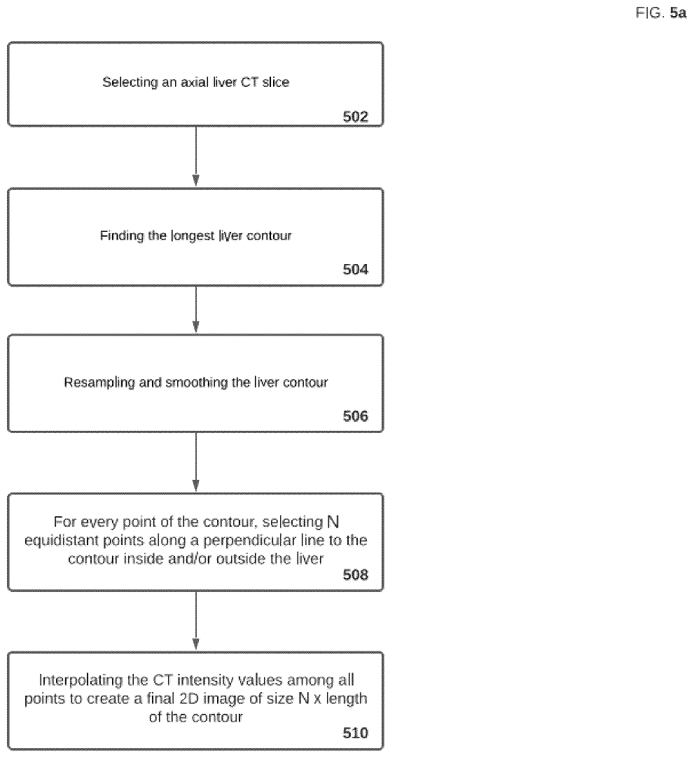

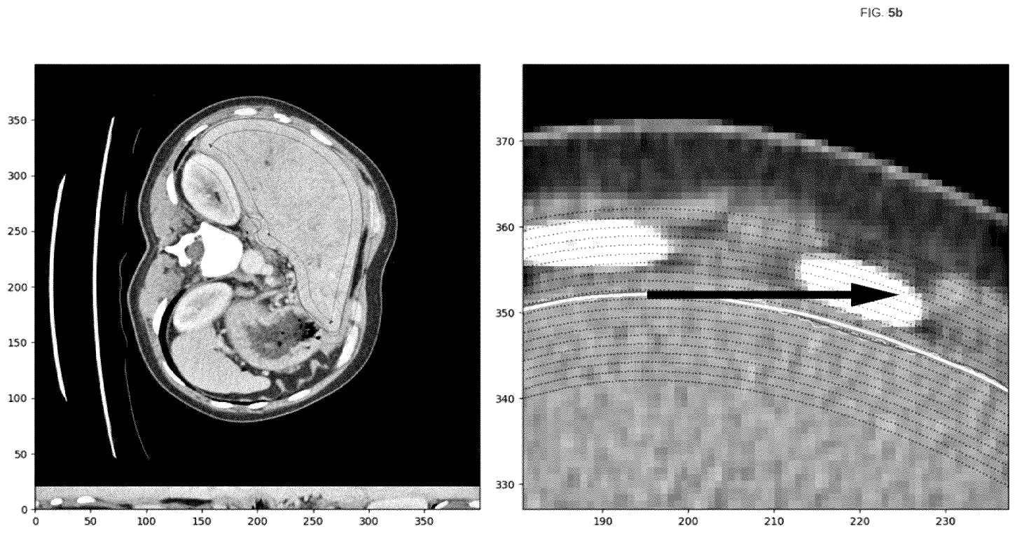

The rectified liver contour consists of a 2D image of a straightened liver contour and its neighbourhood. In an embodiment, the rectified liver contour is obtained with a computer-implemented method. FIG. 5a depicts a flow chart that illustrates an exemplary method for the extraction of a region of interest, in particular the rectified liver contour, in a digital image comprising a liver, in accordance with an example of the invention. The method allows to extract information from the local context of the liver contour and present it in a form of a 2D grayscale image. In the example of implementation of the present invention above described, the following conditions were considered in the implementation: all distance units must be expressed in mm, every contour must have a deterministic common starting point, all normal vectors should have the same consistent direction (inward/outward the liver). In the example of implementation of the present invention above described, the algorithm was configurable with the following parameters: width of the contour in mm, contour smoothing factor, proportion of the outside-liver and inside-liver parts of the contours in the total width. The method comprises the steps of: selecting an axial liver CT slice (502); finding the longest liver contour (504); resampling and smoothing the liver contour (506) such that the contour is defined by points located at a distance of 0.5 mm from each other; for every point of the contour, selecting N equidistant points along a perpendicular line to the contour inside and/or outside the liver (508), where the number N of points depends on the configured parameters (width of the contour, proportion of the outside-liver and inside-liver parts); interpolating the CT intensity values among all N points to create a final 2D image of size N×length of the contour (510). FIG. 5b illustrates the view (left) and a zoomed-in view (right) of an axial liver CT slice with contours marked, comprising a rectified liver contour (bottom part of the left image), in accordance with an example of the invention.

At 306, highly-interpretable features from the at least one region of interest are extracted. Highly-interpretable features are intended as features extractable from a digital image of a CT scan which are, singularly and in combination, anatomically-associable features and thus easily interpretable by a user. Features can be extracted with automatic algorithms or manually-designed algorithms or extractors. In the example of implementation of the present invention above described, some features were extracted with the PyRadiomics tool, an open source Python software package for the extraction of standard radiomics features. Standard radiomics features can amount to thousands of variations, comprising First Order Statistics, Shape-based 3D and 2D, Gray Level Cooccurrence Matrix, Gray Level Run Length Matrix, Gray Level Size Zone Matrix, Neighbouring Gray Tone Difference Matrix, Gray Level Dependence Matrix. Manually-designed extractors were developed and used to extract other features, more easily interpretable than standard radiomics features. Said highly-interpretable features can comprise liver volume, spleen volume, spleen-to-liver ratio, liver volume distribution, liver surface nodularity (LSN), ascites, any standard radiomics features, or any combination thereof. In the example of implementation of the present invention above described, the liver volume and spleen volume are calculated as the number of voxels multiplied by the voxel size, with the number of voxels obtained from the available segmentations (manual and/or AI). For the liver volume: the manual segmentation was used if only one manual segmentation (for one phase of the CT scan) existed; the average of the manual segmentations was used if more than one manual segmentation (one for each phase of the CT scan) existed; the average of the AI segmentations over all available phases was used if no manual segmentation existed. In the example of implementation of the present invention above described, the spleen-to-liver ratio, defined as the spleen volume divided by the liver volume, allows to remove the dependence on sex, weight and partially on race of the patient.

The liver volume distribution can be sensitive to the enlargement or shrinking of different parts of the liver. A caudate-right lobe ratio parameter can be a strong indicator of cirrhosis, however it is difficult to calculate, without knowing the segmentation of the portal vein and the location of its bifurcation. In the example of implementation of the present invention above described, as second best method the skewness and kurtosis of the liver volume distribution in different directions were estimated.

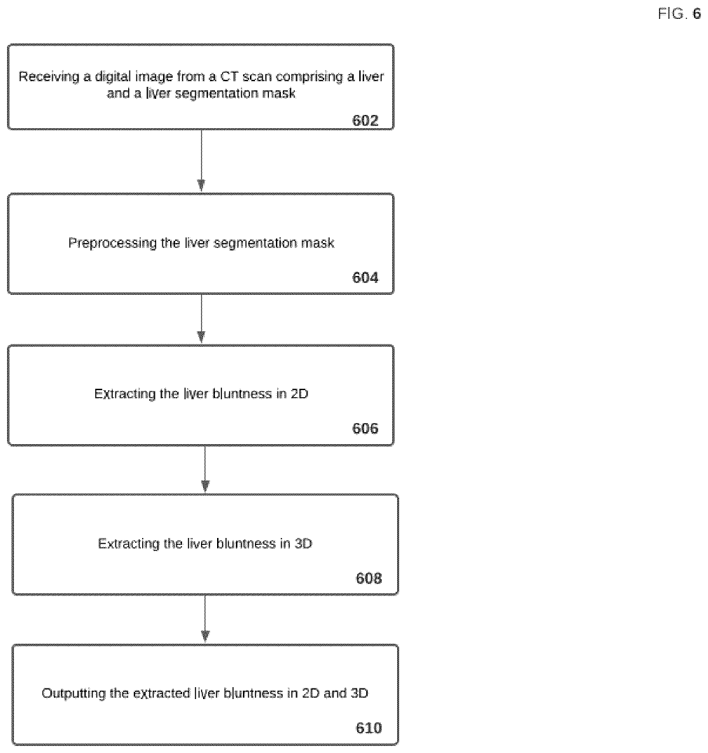

FIG. 6 depicts a flow chart that illustrates an exemplary method for the extraction of a feature, in particular the liver bluntness, in accordance with an example of the invention. Blunted liver corners, in particular the left liver corner, are one of the most common symptoms of cirrhosis. In the example of implementation of the present invention above described, three parameters were introduced to estimate the bluntness of the left liver corner: the corner bluntness in 2D and 3D, calculated as the number of voxels closer than 50 mm from the left liver corner; the corner growth ratio in 2D and 3D, calculated as the corner bluntness in 2D and 3D respectively, divided by the number of voxels closer than 25 mm from the left liver corner; the corner inscribed circle radius in 2D and sphere radius 3D, calculated as the radius of the biggest circle in 2D or sphere in 3D inscribed in the voxels closer than 50 mm from the left liver corner. The values of 50 mm and 25 mm can be arbitrarily adjusted to the size of the typical fibrous appendix of the liver. The method comprises the steps of: receiving a digital image from a CT scan comprising a liver and a liver segmentation mask (602), preprocessing the liver segmentation mask (604), extracting the liver bluntness in 2D (606), extracting the liver bluntness in 3D (608) and outputting the extracted liver bluntness in 2D and 3D (610). In an embodiment, step 604 can comprise the substeps of: filling the holes in the 3D liver segmentation; selecting the biggest connected component in 3D as the main body of the liver, to avoid small false positives present in the AI-generated segmentation masks; resizing the liver segmentation to (1,1,1) mm³ voxel size. In an embodiment, step 606 can comprise the substeps of: selecting the axial CT slice with the largest liver area; selecting as left liver corner the point on the liver mask that is closest to the left front corner of the slice; calculating the smaller corner area as the number of liver segmentation voxels that are less than 25 mm distant from the left liver corner; calculating the corner bluntness as the number of liver segmentation voxels that are less than 50 mm distant from the left liver corner; calculating the corner growth ratio as the ratio between the corner bluntness and the smaller corner area; calculating the corner inscribed circle radius as the radius of the biggest circle inscribed in the area covered by liver segmentation voxels less than 50 mm distant from the left liver corner. In an embodiment, step 608 can comprise the substeps of: selecting as left liver corner the point on the liver mask that is closest to the left front top corner of the slice; calculating the smaller corner volume as the number of liver segmentation voxels that are less than 25 mm distant from the left liver corner; calculating the corner bluntness as the number of liver segmentation voxels that are less than 50 mm distant from the left liver corner; calculating the corner growth ratio as the ratio between the corner bluntness and the smaller corner volume; calculating the corner inscribed sphere radius as the radius of the biggest sphere inscribed in the volume covered by liver segmentation voxels less than 50 mm distant from the left liver corner.

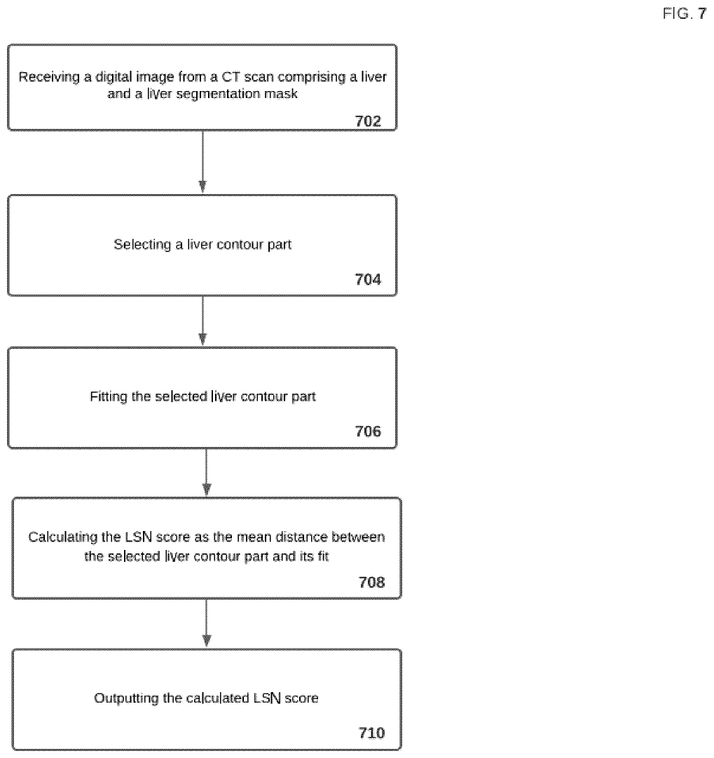

FIG. 7 depicts a flow chart that illustrates an exemplary method for the extraction of a feature, in particular the liver surface nodularity (LSN) or LSN score, in accordance with an example of the invention. The LSN score is one of the most popular metrics with documented effectiveness used to quantify LSN and therefore the grade of liver disease.

The method comprises the steps of: receiving a digital image from a CT scan comprising a liver and a liver segmentation mask (702), selecting a liver contour part (704), fitting the selected liver contour part (706), calculating the LSN score as the mean distance between the selected liver contour part and its fit (708) and outputting the calculated LSN score (710).

In an embodiment, step 704 consisted in systematically selecting the anterior side of the liver, with the anterior side defined as the liver contour part from the anatomically rightmost point of the liver contour, going along the abdomen wall to the anatomically leftmost point of the liver. In the example of implementation of the present invention above described, step 704 comprises the step of finding only high-contrast parts of the liver contour, for example via the substeps of: generating a 5 mm wide rectified liver outside contour on the axial slice with the biggest liver segmentation area; finding the average HU intensities of the voxels in each point of the rectified liver outside contour, with points defined as in step 506; defining the points with negative average as high-contrast points in relation to the liver tissue; cropping an area of the original slice, wherein the area contains the longest streak of high-contrast points; defining the voxels with positive HU in the cropped area as liver voxels; selecting the liver contour part based on the defined liver voxels in the cropped area rather than on the liver segmentation mask. In the example of implementation of the present invention above described, typical lengths of selected liver contour parts measure 8-10 cm. In some embodiments, step 706 can comprise fitting the selected liver contour part with a 2nd-degree polynomial, and/or a 3rd-degree polynomial. In some embodiments, step 708 comprises calculating the LSN score as the mean absolute distance between the selected liver contour part and its fit.

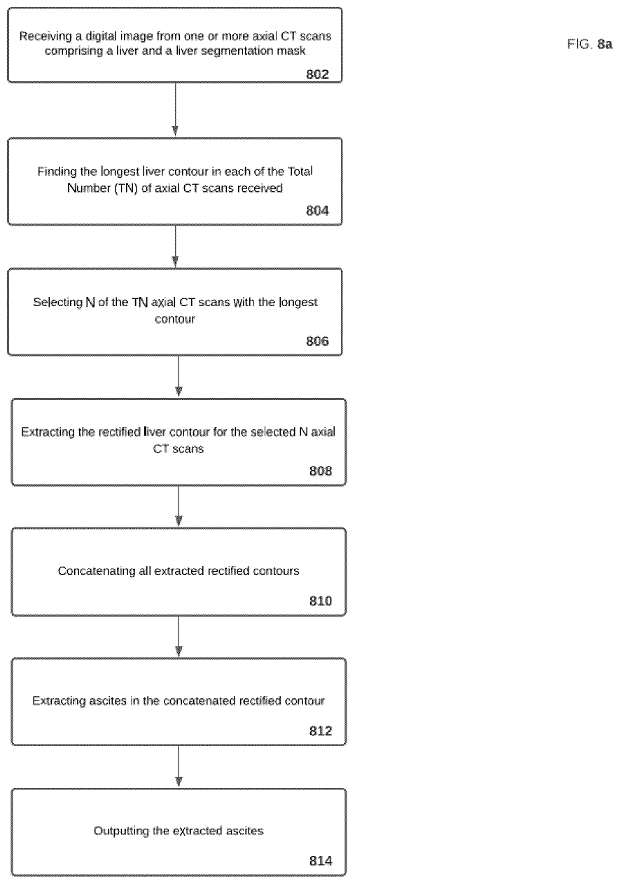

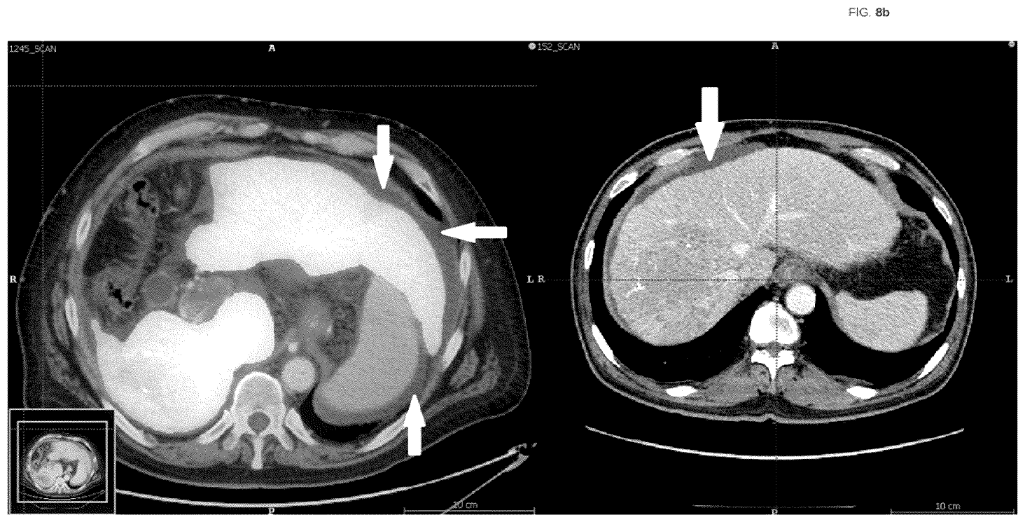

FIG. 8a depicts a flow chart that illustrates an exemplary method for the extraction of a feature, in particular the ascites, in accordance with an example of the invention. The method comprises the steps of: receiving a digital image from one or more axial CT scans comprising a liver and a liver segmentation mask (802), finding the longest liver contour in each of the Total Number (TN) of axial CT scans received (804), selecting N of the TN axial CT scans with the longest contour (806), extracting the rectified liver contour for the selected N axial CT scans (808), concatenating all extracted rectified contours (810), extracting ascites in the concatenated rectified contour (812) and outputting the extracted ascites (814). In the example of implementation of the present invention described above, step 804 is limited to the part of the liver contour comprised between the anatomically rightmost posterior point and the anatomically leftmost anterior point. In the example of implementation of the present invention described above, the parameter N in step 806 is configured to be 10% of the TN and step 808 is performed according to the method described in FIG. 5a. In the example of implementation of the present invention described above, step 812 comprises the substeps of: summing the voxels of 4 different ranges of HUs in the concatenated rectified contour and dividing them by the length of the contour; counting the number of points of the concatenated rectified contour, with points defined as in step 506, where a specific range of HUs fills more than 50% of the total and dividing them by the length of the contour. The 4 different ranges of HUs can be for example: (−10, 10) for transudative ascites, (10, 20) for exudative ascites, (30, 60) for other types of ascites, (−10, 60) for all ascites. In the example of implementation of the present invention described above, step 812 comprises the filtering of thin healthy layers of water, for example thinner than 1 mm in the direction parallel to the contour and thinner than 0.5 mm in the direction perpendicular to the contour. FIG. 8b illustrates examples of ascites indicated by arrows in the CT scans from two patients.

At 308, a subset of the extracted features is identified. In embodiments of the present invention, a subset of features is identified as the subset of the set of extracted features that result in the highest-performant methods to detect liver cirrhosis. The identification of the subset can be performed via a supervised feature selection method, in particular the LASSO method, genetic algorithm, a mixture of the LASSO and genetic algorithm, a sequential feature selection algorithm. The feature selection can also be performed via an unsupervised feature selection method, for example an autoencoder.

LASSO is the most common feature selection method in the context of radiomics. It relies on introducing a penalty to the absolute value (L1 regularization) of the logistic regression feature coefficients. Coefficients of features with low relevance to the target are suppressed down to zero to minimize the cost introduced by the penalty. Therefore, only highly relevant features are able to preserve high coefficients. This method preserves interpretability and takes into account linear relationships between the features.

Genetic algorithm (GA) is a nature-inspired algorithm mimicking natural selection and genome mutations. The algorithm starts from a random initial population of solutions, i.e., 300 different combinations of features, and calculates cirrhosis classification performance for each of them. Then, the population is divided into groups of 3 solutions (tournaments), and the best solution from each tournament is selected for crossover phase. The crossover is a process where each solution has 50% chance of mixing its genotype with other solutions. In the example of implementation of the present invention described above, the genotype is defined as a binary array of length determined by the number of all features. The value of 1 means that the specific feature is selected, the value of 0 means that the specific feature is rejected. There is 20% chance of gene mutation (swapping 0 to 1, or 1 to 0) when creating a new generation, which helps to diversify the population of solutions and avoid local minima. The algorithm stops when there is no improvement in classification performance for best solutions after 20 generations or after a limit of 100 generations is reached. This method preserves interpretability, and it takes into account non-linear relationships between the features. Sequential feature selection (SFS) algorithm is a simple greedy approach that consequently builds relevant and non-redundant sets of features by iteratively adding features with the highest impact on the classification performance. The main advantages of this approach are: it maximizes the classification performance and minimizes the number of features at the same time; when using non-linear classifier (like Random Forest) it takes into account non-linear relationships between features; it is easy to identify and interpret the most important features; it works well for multiple correlated features, while all the redundant features are rejected; it allows for manual selection of required features (i.e., LSN or spleen volume). A fully-connected autoencoder is a neural network which has the same dimensionality of the input and output. The goal of this architecture is to encode the input (i.e., the vector of input features) into latent space of much smaller dimensionality (called bottleneck) such that it is possible to reconstruct the input from this latent representation. Effectively, it is a powerful non-linear method of unsupervised dimensionality reduction. In the example of implementation of the present invention described above, the autoencoder is symmetric and uses mean squared error reconstruction loss. The sizes of the input and output are equal to the number of features after filtering zero-variance features, however correlation-based filtering is not performed to avoid removing features that could be non-linearly correlated with others. The autoencoder should reject highly correlated features by zeroing-out the weights for them. A sigmoid activation is used in the output layer.

In the example of implementation of the present invention above described, all said algorithms were tested.

At 310, by inputting the selected subset of features in the classifier, the liver is classified. In an embodiment, the classifier is a logistic regression classifier. In another embodiment, the classifier is a random forest classifier. In an alternative implementation of the present invention, step 310 is replaced by an unsupervised clustering algorithm, with the goal to cluster with labels all patient scans containing selected features. The clustering algorithm can be, for example, one among the following: K-Means, Affinity Propagation, Agglomerative Clustering, and HDBScan.

At 312, the cirrhotic state of the liver is outputted.

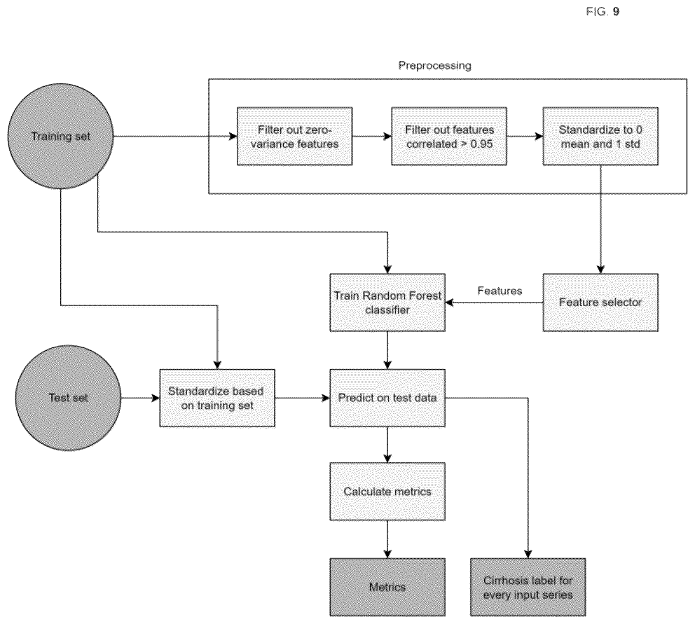

FIG. 9 depicts the classification pipeline that illustrates an exemplary method for liver cirrhosis classification, in accordance with an example of the invention. It consists of two stages: the classifier training with training set features and the classifier testing with test set features. The trained classifier is used for prediction on test set features. In the example of implementation of the present invention above described, the training comprises: preprocessing the training set by filtering out insignificant features (zero variance, high correlation); standardizing input features; running input features through a feature selector to reduce the cardinality of the original input feature set; training the classifier on the training set based on the selected features. The testing comprises: standardizing the test set with statistical parameters calculated during the preprocessing step for the training set; running the prediction on the test set to acquire cirrhosis label for every input series; evaluating the classifier performance by calculating metrics for the test set. Metrics to assess the quality of cirrhosis classification on the test set comprise: the accuracy, the F1 score, the ROC-AUC curve and the Matthews correlation coefficient. Their descriptions are presented below, with the following categories used in the equations:
TP—number of true positives,
TN—number of true negatives,
FP—number of false positives,
FN—number of false negatives.

The accuracy is the ratio between the number of correct predictions and the total number of input samples:

$$ACC = \frac{TP + TN}{TP + TN + FP + FN} .$$

The F1 score is a function of precision and recall. It determines how many instances the model classifies correctly without missing a significant number of instances. This score can be represented by the following equation:

$$F 1 = \frac{2 TP}{2 TP + FP + FN} .$$

The ROC-AUC curve is a performance measurement for the classification problems at various threshold settings. ROC is a probability curve and AUC (Area Under the Curve) represents the degree or measure of separability. The higher the AUC, the better the model is at predicting classes.

The Matthews correlation coefficient takes into account true negatives, true positives, false negatives and false positives. This reliable measure produces high scores only if the prediction returns good rates for all four of these categories. The Matthews correlation coefficient ranges from −1 to 1, with −1 indicating perfect misclassification and +1 perfect classification. The Matthews correlation coefficient is more informative than F1 score and accuracy in evaluating binary classification problems since it works well for imbalanced datasets and takes into account the balance ratios of the four confusion matrix categories. The Matthews correlation coefficient can be represented by the following equation:

$$M C C = \frac{TP \times TN - FP \times FN}{√ ( TP + FP ) ( TP + FN ) ( TN + FP ) ( TN + FN )} .$$

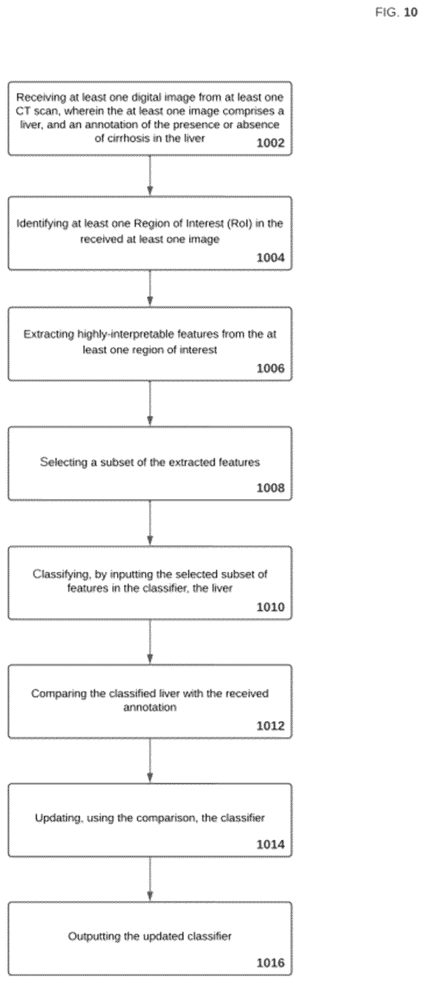

FIG. 10 depicts a flow chart that illustrates an exemplary method for cirrhosis detection in a digital image, in accordance with an example of the invention. At 1002, at least one digital image from at least one CT scan is received, wherein the at least one image comprises a liver, and an annotation of the presence or absence of cirrhosis in the liver. In an embodiment of the present invention, a step of preprocessing the received at least one digital image is performed. The step of preprocessing can comprise the steps of removing corrupted images, and/or images with inconsistent annotations, and/or images with incomplete livers. At 1004, at least one Region of Interest (RoI) in the received at least one image is identified. RoIs are regions in the image where objects of interest can be found, for example the liver. RoIs can be identified via AI algorithms, in particular ML algorithms. In the example of implementation of the present invention above described, 3 RoIs were extracted: liver volume, spleen volume, and rectified liver contour. At 1006, highly-interpretable features from the at least one region of interest are extracted. Highly-interpretable features are intended as features extractable from a digital image of a CT scan which are, singularly and in combination, anatomically-associable features and thus easily interpretable by a user. Features can be extracted with automatic algorithms or manually-designed algorithms or extractors. In an embodiment of the present invention, highly-interpretable features comprise liver bluntness, liver surface nodularity (LSN), ascites. At 1008, a subset of the extracted features is identified. In embodiments of the present invention, a subset of features is identified as the subset of the set of extracted features that result in the highest-performant methods to detect liver cirrhosis. The identification of the subset can be performed via a supervised feature selection method, in particular the LASSO method, genetic algorithm, a mixture of the LASSO and genetic algorithm, a sequential feature selection algorithm. The feature selection can also be performed via an unsupervised feature selection method, for example an autoencoder. At 1010, by inputting the selected subset of features in the classifier, the liver is classified. In an embodiment, the classifier is a logistic regression classifier. In another embodiment, the classifier is a random forest classifier. In an embodiment, the liver is classified as cirrhotic or not cirrhotic. At 1012, the classified liver is compared with the received annotation. This step comprises using a loss function to quantify the comparison. At 1014, using the comparison, the classifier is updated. For example, using the loss function to quantify the difference between the classified liver and the annotation, which represents the ground truth, the parameters of the classifier are updated. At 1016, the updated classifier is outputted. For example, the classifier with the parameters corresponding to the minimum of the loss function is outputted.

### Embodiments

In the following, further particular embodiments of the present invention are listed.
1. In an embodiment, a computer-implemented method of training a classifier for liver cirrhosis detection is disclosed, the method comprising the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest, wherein highly-interpretable features consist of anatomically-associable features, and in particular liver bluntness, liver surface nodularity (LSN), ascites;
   d. selecting a subset of the extracted features;
   e. classifying, by inputting the selected subset of features in the classifier, the liver;
   f. comparing the classified liver with the received annotation;
   g. updating, using said comparison, the classifier;
   h. outputting the updated classifier.
2. In an embodiment, a computer-implemented method of training a classifier for liver cirrhosis detection is disclosed, the method consisting of the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest;
   d. selecting a subset of the extracted features, wherein highly-interpretable features consist of anatomically-associable features, and in particular liver bluntness, liver surface nodularity (LSN), ascites;
   e. classifying, by inputting the selected subset of features in the classifier, the liver, wherein classifying the liver comprises defining the presence or absence of cirrhosis in the liver;
   f. comparing the classified liver with the received annotation;
   g. updating, using said comparison, the classifier;
   h. outputting the updated classifier.
3. In an embodiment, a computer-implemented method of training a classifier for liver cirrhosis detection is disclosed, the method comprising the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest;
   d. selecting a subset of the extracted features;
   e. classifying, by inputting the selected subset of features in the classifier, the liver;
   f. outputting the cirrhotic state of the liver.
4. In an embodiment, a computer-implemented method of training a classifier for liver cirrhosis detection is disclosed, the method consisting of the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest;
   d. selecting a subset of the extracted features;
   e. classifying, by inputting the selected subset of features in the classifier, the liver;
   f. outputting the cirrhotic state of the liver.
5. In an embodiment, the method of any of the preceding embodiments is disclosed, wherein the steps are performed sequentially.
6. In an embodiment, the method of any of the preceding embodiments is disclosed, wherein received digital images correspond to slices of the same CT scan.
7. In an embodiment, the method of any of the preceding embodiments is disclosed, wherein the received at least one digital image comprises a spleen.
8. In an embodiment, the method of any of the preceding embodiments is disclosed, wherein the received at least one digital image is obtained from at least one portal/venous CT scan.
9. In an embodiment, the method of any of the preceding embodiments is disclosed, wherein the received at least one digital image is obtained from at least one portal/venous CT scan, or arterial CT scan, or other CT scans.
10. In an embodiment, the method of any of the preceding embodiments is disclosed, wherein the received at least one digital image is obtained from at least one arterial CT scan.
11. In an embodiment, the method of any of the preceding embodiments is disclosed, wherein the received digital images correspond to slices of portal/venous CT scans and arterial CT scans.
12. In an embodiment, the method of any of the preceding embodiments is disclosed, further comprising the step of preprocessing the received at least one digital image.
13. In an embodiment, the method of the preceding embodiment is disclosed, wherein the preprocessing comprises the steps of removing corrupted images, and/or images with inconsistent annotations, and/or images with incomplete livers.
14. In an embodiment, the method of any of the preceding embodiments is disclosed, wherein the identified regions of interest comprise liver, spleen and rectified liver contour.
15. In an embodiment, the method of any of the preceding embodiments is disclosed, wherein the identified regions of interest consist of liver, spleen and rectified liver contour.
16. In an embodiment, the method of any of the preceding embodiments is disclosed, wherein the identified regions of interest comprise liver and rectified liver contour.
17. In an embodiment, the method of any of the preceding embodiments is disclosed, wherein the identified regions of interest comprise liver and spleen.
18. In an embodiment, the method of any of the preceding embodiments is disclosed, wherein the step of identifying at least one region of interest is performed via an AI-generated segmentation algorithm.
19. In an embodiment, the method of any of the preceding embodiments is disclosed, wherein the step of identifying at least one region of interest is performed via an AI-generated segmentation algorithm preceded by a voxel normalization step.
20. In an embodiment, the method of any of the preceding embodiments is disclosed, wherein the step of identifying the regions of interest comprising liver and spleen is performed via an AI-generated segmentation algorithm preceded by a voxel normalization step.
21. In an embodiment, the method of any of the preceding embodiments is disclosed, wherein the step of identifying at least one region of interest is performed via a customized algorithm.
22. In an embodiment, the method of any of the preceding embodiments is disclosed, wherein the step of identifying the region of interest consisting of the rectified liver contour is performed via a customized algorithm.
23. In an embodiment, the method of any of the preceding embodiments is disclosed, wherein the extracted highly-interpretable features are anatomically-associable features.
24. In an embodiment, the method of any of the preceding embodiments is disclosed, wherein the extracted highly-interpretable features comprise liver volume, spleen volume, spleen-to-liver ratio, liver bluntness, liver surface nodularity (LSN), ascites, any standard radiomics features, or any combination thereof.
25. In an embodiment, the method of any of the preceding embodiments is disclosed, wherein the extracted highly-interpretable feature consist of liver volume, spleen volume, spleen-to-liver ratio, liver bluntness, liver surface nodularity (LSN), ascites.
26. In an embodiment, the method of any of the preceding embodiments is disclosed, wherein the extracted highly-interpretable features comprise standard radiomics features related to the texture of the liver and liver contour.
27. In an embodiment, the method of any of the preceding embodiments is disclosed, wherein the step of extracting highly-interpretable features is performed via the PyRadiomics tool.
28. In an embodiment, the method of the preceding embodiment is disclosed, wherein the PyRadiomics tool settings are pre-adjusted to the received image.
29. In an embodiment, the method of any of the preceding embodiments is disclosed, wherein the step of extracting highly-interpretable features is performed via manually-designed extractors.
30. In an embodiment, the method of the preceding embodiment is disclosed, wherein the highly-interpretable features extracted with manually-designed extractors comprise liver volume, spleen volume, spleen-to-liver ratio, liver bluntness, liver surface nodularity (LSN), ascites.
31. In an embodiment, the method of any of the preceding embodiments is disclosed, wherein the feature selection comprises the identification of a subset of the set of extracted features, wherein the subset results in the highest-performing classifier.
32. In an embodiment, the method of any of the preceding embodiments is disclosed, wherein the feature selection is performed using a supervised feature selection method, in particular the LASSO method.
33. In an embodiment, the method of any of the preceding embodiments is disclosed, wherein the feature selection is performed using a supervised feature selection method.
34. In an embodiment, the method of any of the preceding embodiments is disclosed, wherein the feature selection is performed using a supervised feature selection method, in particular a genetic algorithm.
35. In an embodiment, the method of any of the preceding embodiments is disclosed, wherein the feature selection is performed using a combination of a LASSO method and a genetic algorithm.
36. In an embodiment, the method of any of the preceding embodiments is disclosed, wherein the feature selection is performed using a supervised feature selection method, in particular a sequential feature selection algorithm.
37. In an embodiment, the method of any of the preceding embodiments is disclosed, wherein the feature selection is performed via an unsupervised feature selection method, in particular an autoencoder.
38. In an embodiment, the method of any of the preceding embodiments is disclosed, wherein the feature selection comprises a step of pre-selection, wherein the pre-selection step comprises filtering out features with zero variance or highly-correlated features.
39. In an embodiment, the method of any of the preceding embodiments is disclosed, wherein the feature selection comprises a step of pre-selection, wherein the pre-selection step comprises filter out features with zero variance and highly-correlated features.
40. In an embodiment, the method of any of the preceding embodiments is disclosed, wherein the feature selection comprises a step of feature normalization.
41. In an embodiment, the method of any of the preceding embodiments is disclosed, wherein the feature selection comprises a step of feature normalization to mean equal to 0 and standard deviation equal to 1.
42. In an embodiment, the method of any of the preceding embodiments is disclosed, wherein the classifier is a logistic regression classifier.
43. In an embodiment, the method of any of the preceding embodiments is disclosed, wherein the classifier is a random forest classifier.
44. In an embodiment, a computer-implemented method for liver cirrhosis detection is disclosed, wherein the method comprises the steps of:
   a. receiving at least one digital image from at least one CT scan, wherein the at least one image comprises a liver;
   b. classifying the liver, by inputting the received at least one digital image in a classifier trained according to any of the preceding claims, wherein the classifier is a logistic regression classifier and/or a random forest classifier;
   c. outputting the cirrhotic state of the liver.
45. In an embodiment, the method of the preceding embodiment is disclosed, wherein the method consists of the steps of:
   a. receiving at least one digital image from at least one CT scan, wherein the at least one image comprises a liver;
   b. classifying the liver, by inputting the received at least one digital image in a classifier trained according to any of the preceding claims, wherein the classifier is a logistic regression classifier and/or a random forest classifier;
   c. outputting the cirrhotic state of the liver.
46. In an embodiment, the method of the embodiments following and including embodiment 42 is disclosed, wherein the received at least one digital image comprises a spleen.
47. In an embodiment, the method of the embodiments following and including embodiment 42 is disclosed, wherein the received at least one digital image is obtained from at least one portal/venous CT scan, or arterial CT scan, or other CT scans.
48. In an embodiment, the method of the embodiments following and including embodiment 42 is disclosed, wherein the received at least one digital image is obtained from at least one portal/venous CT scan.
49. In an embodiment, the method of the embodiments following and including embodiment 42 is disclosed, wherein the received at least one digital image is obtained from at least one arterial CT scan.
50. In an embodiment, the method of the embodiments following and including embodiment 42 is disclosed, wherein the received digital images correspond to slices of portal/venous CT scans and arterial CT scans.
51. In an embodiment, the method of the embodiments following and including embodiment 42 is disclosed, further comprising the step of preprocessing the received at least one digital image.
52. In an embodiment, the method of the embodiments following and including embodiment 42 is disclosed, wherein the preprocessing comprises the steps of removing corrupted images, and/or images with inconsistent annotations, and/or images with incomplete livers.
53. In an embodiment, the method of the embodiments following and including embodiment 42 is disclosed, wherein the classifier is a logistic regression classifier.
54. In an embodiment, the method of the embodiments following and including embodiment 42 is disclosed, wherein the classifier is a random forest classifier.
55. In an embodiment, the method of the embodiments following and including embodiment 42 is disclosed, further comprising a step to evaluate the classifier performance via a metrics calculation.
56. In an embodiment, the method of the preceding embodiment is disclosed, wherein the metrics comprise accuracy, or F1 score, or ROC AUC, or Matthews correlation coefficients, or any combination thereof.
57. In an embodiment, a system is disclosed comprising:
   a. an input/output (I/O) unit (202) configured to receive at least one digital image from at least one CT scan, wherein the at least one image comprises a liver, and an annotation of the presence or absence of cirrhosis in the liver;
   b. a processor (204) configured to perform the steps of:
      i. identifying at least one region of interest in the received at least one image;
      ii. extracting highly-interpretable features from the at least one region of interest, wherein highly-interpretable features consist of anatomically-associable features, and in particular liver bluntness, liver surface nodularity (LSN), ascites;
      iii. selecting a subset of the extracted features;
      iv. classifying, by inputting the selected subset of features in the classifier, the liver, wherein classifying the liver comprises defining the presence or absence of cirrhosis in the liver;
      v. comparing the classified liver with the received annotation;
      vi. updating, using said comparison, the classifier;
      vii. outputting the updated classifier.
58. In an embodiment, a system is disclosed consisting of:
   a. an input/output (I/O) unit (202) configured to receive at least one digital image from at least one CT scan, wherein the at least one image comprises a liver, and an annotation of the presence or absence of cirrhosis in the liver;
   b. a processor (204) configured to perform the steps of:
      i. identifying at least one region of interest in the received at least one image;
      ii. extracting highly-interpretable features from the at least one region of interest, wherein highly-interpretable features consist of anatomically-associable features, and in particular liver bluntness, liver surface nodularity (LSN), ascites;
      iii. selecting a subset of the extracted features;
      iv. classifying, by inputting the selected subset of features in the classifier, the liver, wherein classifying the liver comprises defining the presence or absence of cirrhosis in the liver;
      v. comparing the classified liver with the received annotation;
      vi. updating, using said comparison, the classifier;
      vii. outputting the updated classifier.
59. In an embodiment, a system is disclosed comprising:
   a. an input/output (I/O) unit (202) configured to receive at least one digital image from at least one CT scan, wherein the at least one image comprises a liver, and an annotation of the presence or absence of cirrhosis in the liver;
   b. a processor (204) configured to perform the steps of:
      i. identifying at least one region of interest in the received at least one image;
      ii. extracting highly-interpretable features from the at least one region of interest;
      iii. selecting a subset of the extracted features;
      iv. classifying, by inputting the selected subset of features in the classifier, the liver;
      v. outputting the cirrhotic state of the liver.
60. In an embodiment, a system is disclosed consisting of:
   a. an input/output (I/O) unit (202) configured to receive at least one digital image from at least one CT scan, wherein the at least one image comprises a liver, and an annotation of the presence or absence of cirrhosis in the liver;
   b. a processor (204) configured to perform the steps of:
      i. identifying at least one region of interest in the received at least one image;
      ii. extracting highly-interpretable features from the at least one region of interest;
      iii. selecting a subset of the extracted features;
      iv. classifying, by inputting the selected subset of features in the classifier, the liver;
      v. outputting the cirrhotic state of the liver.
61. In an embodiment, a computer program product is disclosed comprising instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest, wherein highly-interpretable features consist of anatomically-associable features, and in particular liver bluntness, liver surface nodularity (LSN), ascites;
   d. selecting a subset of the extracted features;
   e. classifying, by inputting the selected subset of features in the classifier, the liver, wherein classifying the liver comprises defining the presence or absence of cirrhosis in the liver;
   f. comparing the classified liver with the received annotation;
   g. updating, using said comparison, the classifier;
   h. outputting the updated classifier.
62. In an embodiment, a computer program product is disclosed consisting of instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest, wherein highly-interpretable features consist of anatomically-associable features, and in particular liver bluntness, liver surface nodularity (LSN), ascites;
   d. selecting a subset of the extracted features;
   e. classifying, by inputting the selected subset of features in the classifier, the liver, wherein classifying the liver comprises defining the presence or absence of cirrhosis in the liver;
   f. comparing the classified liver with the received annotation;
   g. updating, using said comparison, the classifier;
   h. outputting the updated classifier.
63. In an embodiment, a computer program product is disclosed comprising instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest;
   d. selecting a subset of the extracted features;
   e. classifying, by inputting the selected subset of features in the classifier, the liver;
   f. outputting the cirrhotic state of the liver.
64. In an embodiment, a computer program product is disclosed consisting of instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest;
   d. selecting a subset of the extracted features;
   e. classifying, by inputting the selected subset of features in the classifier, the liver;
   f. outputting the cirrhotic state of the liver.
65. In an embodiment, a computer-readable storage medium is disclosed comprising instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest, wherein highly-interpretable features consist of anatomically-associable features, and in particular liver bluntness, liver surface nodularity (LSN), ascites;
   d. selecting a subset of the extracted features;
   e. classifying, by inputting the selected subset of features in the classifier, the liver, wherein classifying the liver comprises defining the presence or absence of cirrhosis in the liver;
   f. comparing the classified liver with the received annotation;
   g. updating, using said comparison, the classifier;
   h. outputting the updated classifier.
66. In an embodiment, a computer-readable storage medium is disclosed consisting of instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest, wherein highly-interpretable features consist of anatomically-associable features, and in particular liver bluntness, liver surface nodularity (LSN), ascites;
   d. selecting a subset of the extracted features;
   e. classifying, by inputting the selected subset of features in the classifier, the liver, wherein classifying the liver comprises defining the presence or absence of cirrhosis in the liver;
   f. comparing the classified liver with the received annotation;
   g. updating, using said comparison, the classifier;
   h. outputting the updated classifier.
67. In an embodiment, a computer-readable storage medium is disclosed comprising instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest;
   d. selecting a subset of the extracted features;
   e. classifying, by inputting the selected subset of features in the classifier, the liver;
   f. outputting the cirrhotic state of the liver.
68. In an embodiment, a computer-readable storage medium is disclosed consisting of instructions which, when the program is executed by a computer, cause the computer to carry out the steps of:
   a. receiving at least one digital image from at least one CT scan, wherein the at least one image comprises a liver, and an annotation of the presence or absence of cirrhosis in the liver;
   b. identifying at least one region of interest in the received at least one image;
   c. extracting highly-interpretable features from the at least one region of interest;
   d. selecting a subset of the extracted features;
   e. classifying, by inputting the selected subset of features in the classifier, the liver;
   f. outputting the cirrhotic state of the liver.
69. In an embodiment, a computer-implemented method to extract liver bluntness is disclosed, the method comprising the steps of:
   a. receiving a digital image from a CT scan comprising a liver and a liver segmentation mask (602);
   b. preprocessing the received liver segmentation mask (604);
   c. extracting from the preprocessed liver segmentation mask the liver bluntness in 2D (606);
   d. extracting from the preprocessed liver segmentation mask the liver bluntness in 3D (608);
   e. outputting the extracted liver bluntness in 2D and 3D (610).
70. In an embodiment, the method of the preceding embodiment is disclosed, wherein the liver corners comprise the left liver corner.
71. In an embodiment, the method of the embodiments following and including embodiment 61 is disclosed, wherein the step of preprocessing the received liver segmentation mask comprises the substeps of:
   a. filling the holes in the 3D liver segmentation;
   b. selecting the biggest connected component in 3D as the main body of the liver;
   c. resizing the liver segmentation to (1,1,1) mm³ voxel size.
72. In an embodiment, the method of the embodiments following and including embodiment 61 is disclosed, wherein the step of extracting the liver bluntness in 2D comprises the substeps of:
   a. selecting the axial CT slice with the largest liver area;
   b. selecting as left liver corner the point on the liver mask that is closest to the left front corner of the slice;
   c. calculating the smaller corner area as the number of liver segmentation voxels that are less than 25 mm distant from the left liver corner;
   d. calculating the corner bluntness as the number of liver segmentation voxels that are less than 50 mm distant from the left liver corner;
   e. calculating the corner growth ratio as the ratio between the corner bluntness and the smaller corner area;
   f. calculating the corner inscribed circle radius as the radius of the biggest circle inscribed in the area covered by liver segmentation voxels less than 50 mm distant from the left liver corner.
73. In an embodiment, the method of the embodiments following and including embodiment 61 is disclosed, wherein the step of extracting the liver bluntness in 3D comprises the substeps of:
   a. selecting as left liver corner the point on the liver mask that is closest to the left front top corner of the slice;
   b. calculating the smaller corner volume as the number of liver segmentation voxels that are less than 25 mm distant from the left liver corner;
   c. calculating the corner bluntness as the number of liver segmentation voxels that are less than 50 mm distant from the left liver corner;
   d. calculating the corner growth ratio as the ratio between the corner bluntness and the smaller corner volume;
   e. calculating the corner inscribed sphere radius as the radius of the biggest sphere inscribed in the volume covered by liver segmentation voxels less than 50 mm distant from the left liver corner.
74. In an embodiment, a computer-implemented method to extract liver surface nodularity (LSN) or LSN score is disclosed, the method comprising the steps of:
   a. receiving a digital image from a CT scan comprising a liver and a liver segmentation mask (702);
   b. selecting a liver contour part (704);
   c. fitting the selected liver contour part (706);
   d. calculating the LSN score as the mean distance between the selected liver contour part and its fit (708);
   e. outputting the calculated LSN score (710).
75. In an embodiment, the method of the preceding embodiment is disclosed, wherein the step of selecting a liver contour part comprises the substeps of:
   a. generating a 5 mm wide rectified liver outside contour on the axial slice with the biggest liver segmentation area;
   b. finding the average HU intensities of the voxels in each point of the rectified liver outside contour, with points defined as in 506;
   c. defining the points with negative average as high-contrast points in relation to the liver tissue;
   d. cropping an area of the original slice, wherein the area contains the longest streak of high-contrast points;
   e. defining the voxels with positive HU in the cropped area as liver voxels;
   f. selecting the liver contour part based on the defined liver voxels in the cropped area rather than on the liver segmentation mask.
76. In an embodiment, the method of the embodiments following and including embodiment 66 is disclosed, wherein the length of the selected liver contour part is between 8 cm and 10 cm.
77. In an embodiment, the method of the embodiments following and including embodiment 66 is disclosed, wherein the selected liver contour part is fitted with a polynomial function.
78. In an embodiment, the method of the embodiments following and including embodiment 66 is disclosed, wherein the selected liver contour part is fitted with a 2nd-degree polynomial function.
79. In an embodiment, the method of the embodiments following and including embodiment 66 is disclosed, wherein the selected liver contour part is fitted with a 3rd-degree polynomial function.
80. In an embodiment, the method of the embodiments following and including embodiment 66 is disclosed, wherein the LSN score is calculated as the mean absolute distance between the selected liver contour part and its fit.
81. In an embodiment, a computer-implemented method to extract ascites is disclosed, the method comprising the steps of:
   a. receiving a digital image from one or more axial CT scans comprising a liver and a liver segmentation mask (802);
   b. finding the longest liver contour in each of the Total Number (TN) of axial CT scans received (804);
   c. selecting N of the TN axial CT scans with the longest contour (806);
   d. extracting the rectified liver contour for the selected N axial CT scans (808);
   e. concatenating all extracted rectified contours (810);
   f. extracting ascites in the concatenated rectified contour (812);
   g. outputting the extracted ascites (814).
82. In an embodiment, the method of the preceding embodiment is disclosed, wherein the step of finding the longest liver contour is limited to the part of the liver contour comprised between the anatomically rightmost posterior point and the anatomically leftmost anterior point.
83. In an embodiment, the method of the embodiments following and including embodiment 73 is disclosed, wherein the parameter N is configured to be 10% of the TN of received axial CT scans.
84. In an embodiment, the method of the embodiments following and including embodiment 73 is disclosed, wherein the step of detecting ascites in the concatenated rectified contour comprises the substeps of:
   a. summing the voxels of different ranges of HUs in the concatenated rectified contour and dividing them by the length of the contour;
   b. counting the number of points of the concatenated rectified contour where a specific range of HUs fills more than 50% of the total and dividing them by the length of the contour.
85. In an embodiment, the method of the embodiments following and including embodiment 73 is disclosed, wherein the step of detecting ascites in the concatenated rectified contour comprises the substep of filtering thin healthy layers of water, for example thinner than 1 mm in the direction parallel to the contour and thinner than 0.5 mm in the direction perpendicular to the contour.

1. A computer-implemented method of training a classifier for liver cirrhosis detection, the method comprising the steps of:
a. receiving at least one digital image from at least one CT scan, wherein the at least one image comprises a liver, and an annotation of the presence or absence of cirrhosis in the liver (1002);
b. identifying at least one region of interest in the received at least one image (1004);
c. extracting highly-interpretable features from the at least one region of interest (1006), wherein highly-interpretable features consist of anatomically-associable features, and in particular liver bluntness, liver surface nodularity (LSN), ascites;
d. selecting a subset of the extracted features (1008);
e. classifying, by inputting the selected subset of features in the classifier, the liver (1010), wherein classifying the liver comprises defining the presence or absence of cirrhosis in the liver;
f. comparing the classified liver with the received annotation (1012);
g. updating, using said comparison, the classifier (1014);
h. outputting the updated classifier (1016).

2. The method of claim 1, wherein the received at least one digital image comprises a spleen.

3. The method of claim 1, wherein the received at least one digital image is obtained from at least one portal/venous phase CT scan.

4. The method of claim 1, further comprising the step of preprocessing the received at least one digital image.

5. The method of claim 1, wherein the identified regions of interest comprise liver, spleen and rectified liver contour.

6. The method of claim 1, wherein the extracted highly-interpretable features comprise liver volume, spleen volume, spleen-to-liver ratio, liver bluntness, liver surface nodularity (LSN), ascites, any standard radiomics features, or any combination thereof.

7. The method of claim 1, wherein the feature selection is performed using a supervised feature selection method, in particular the LASSO method.

8. (canceled)

9. A system comprising:
a. an input/output (I/O) unit (202) configured to receive at least one digital image from at least one CT scan, wherein the at least one image comprises a liver, and an annotation of the presence or absence of cirrhosis in the liver;
b. a processor (204) configured to perform the steps of:
i. identifying at least one region of interest in the received at least one image;
ii. extracting highly-interpretable features from the at least one region of interest, wherein highly-interpretable features consist of anatomically-associable features, and in particular liver bluntness, liver surface nodularity (LSN), ascites;
iii. selecting a subset of the extracted features;
iv. classifying, by inputting the selected subset of features in the classifier, the liver, wherein classifying the liver comprises defining the presence or absence of cirrhosis in the liver;
v. comparing the classified liver with the received annotation;
vi. updating, using said comparison, the classifier;
vii. outputting the updated classifier.

10. (canceled)

11. A computer-readable storage medium comprising instructions which, when the program is executed by a computer, cause the computer to carry out the steps of:
a. receiving at least one digital image from at least one CT scan, wherein the at least one image comprises a liver, and an annotation of the presence or absence of cirrhosis in the liver;
b. identifying at least one region of interest in the received at least one image;
c. extracting highly-interpretable features from the at least one region of interest, wherein highly-interpretable features consist of anatomically-associable features, and in particular liver bluntness, liver surface nodularity (LSN), ascites;
d. selecting a subset of the extracted features;
e. classifying, by inputting the selected subset of features in the classifier, the liver, wherein classifying the liver comprises defining the presence or absence of cirrhosis in the liver;
f. comparing the classified liver with the received annotation;
g. updating, using said comparison, the classifier;
h. outputting the updated classifier.

12. A method to extract liver bluntness, the method comprising the steps of:
a. receiving a digital image from a CT scan comprising a liver and a liver segmentation mask (602);
b. preprocessing the received liver segmentation mask (604);
c. extracting from the preprocessed liver segmentation mask the liver bluntness in 2D (606);
d. extracting from the preprocessed liver segmentation mask the liver bluntness in 3D (608);
e. outputting the extracted liver bluntness in 2D and 3D (610).

13. A method to extract liver surface nodularity (LSN) or LSN score, the method comprising the steps of:
a. receiving a digital image from a CT scan comprising a liver and a liver segmentation mask (702);
b. selecting a liver contour part (704);
c. fitting the selected liver contour part (706);
d. calculating the LSN score as the mean distance between the selected liver contour part and its fit (708);
e. outputting the calculated LSN score (710).

14. A method to extract ascites, the method comprising the steps of:
a. receiving a digital image from one or more axial CT scans comprising a liver and a liver segmentation mask (802);
b. finding the longest liver contour in each of the Total Number (TN) of axial CT scans received (804);
c. selecting N of the TN axial CT scans with the longest contour (806);
d. extracting the rectified liver contour for the selected N axial CT scans (808);
e. concatenating all extracted rectified contours (810);
f. extracting ascites in the concatenated rectified contour (812);
g. outputting the extracted ascites (814).

15. (canceled)
